(19) United States
(12) Patent Application Publication
(10) Pub. No.: US 2025/0249566 A1
(43) Pub. Date: Aug. 7, 2025

(54) POWER TOOL AND OPERATING METHOD THEREFOR

(71) Applicant: Nanjing Chervon Industry Co., Ltd., Nanjing (CN)

(72) Inventors: Manfei Xu, Nanjing (CN); Wei Lu, Nanjing (CN); Jiajun Wu, Nanjing (CN); Rong Fan, Nanjing (CN); Chao Meng, Nanjing (CN); Zichun Tang, Nanjing (CN); Chengbin Wang, Nanjing (CN); Changjiang Wei, Nanjing (CN)

(21) Appl. No.: 18/978,895

(22) Filed: Dec. 12, 2024

(30) Foreign Application Priority Data
Feb. 7, 2024 (CN) 202410176718.X
Feb. 20, 2024 (CN) 202420321071.0
Feb. 28, 2024 (CN) 202420366622.5
Feb. 28, 2024 (CN) 202420373296.0

(51) Int. Cl. B25F 5/00; B25B 21/00

(52) U.S. Cl. CPC B25F 5/001; B25B 21/00

(57) ABSTRACT

A power tool includes a housing, an electric motor, a switch assembly, and a directional assembly. The motor is disposed at least partially in the housing and includes a rotating shaft rotatable about a first axis. The switch assembly is operable to switch between a startup position and a shutdown position. The switch assembly sends a startup signal to the motor at the startup position. The switch assembly sends a shutdown signal to the motor at the shutdown position. The directional assembly is for the user to operate to control a rotation direction of the electric motor. The directional assembly is further configured to mate with the switch assembly to lock the switch assembly at the startup position. When the directional assembly is operated to be disengaged from the switch assembly to unlock the switch assembly, the switch assembly switches to the shutdown position.

### RELATED APPLICATION INFORMATION

This application claims the benefit under 35 U.S.C. § 119(a) of Chinese Patent Application No. 202410176718.X, filed on Feb. 7, 2024, Chinese Patent Application No. 202420321071.0, filed on Feb. 20, 2024, Chinese Patent Application No. 202420373296.0, filed on Feb. 28, 2024, and Chinese Patent Application No. 202420366622.5, filed on Feb. 28, 2024, which applications are incorporated herein by reference in their entireties.

### BACKGROUND

Power tools are more environmentally friendly than engine-powered tools and thus are widely applied. An electric screwdriver is a power tool for mounting and removing screws and includes a housing, an electric motor, a battery, and a trigger to achieve the forward and reverse rotation of the electric motor and a locked state.

An existing electric screwdriver switches between circuits by using a directional assembly to achieve the forward and reverse rotation of the electric motor and locks the trigger by mating a circular structure with the trigger. The trigger is pressed again to be unlocked so that the electric motor stops rotating. During use of the existing electric screwdriver, the trigger is easy to touch by accident and unlock, causing the electric screwdriver to stop rotating. The trigger is locked with poor reliability, affecting the work efficiency and quality.

This part provides background information related to the present application, and the background information is not necessarily the existing art.

### SUMMARY

A power tool includes a housing, an electric motor, and a switch assembly.

The electric motor is disposed at least partially in the housing and includes a rotating shaft rotatable about a first axis.

The switch assembly is for a user to operate to switch between a startup position and a shutdown position, the switch assembly at the startup position sends a startup signal to the electric motor, and the switch assembly at the shutdown position sends a shutdown signal to the electric motor.

The power tool further includes a directional assembly.

The directional assembly is for the user to operate to control a rotation direction of the electric motor.

The directional assembly is further configured to mate with the switch assembly to lock the switch assembly at the startup position.

When the directional assembly is operated to be disengaged from the switch assembly to unlock the switch assembly, the switch assembly switches to the shutdown position.

In some examples, the directional assembly includes a directional member and a first stop portion disposed on the directional member, the switch assembly includes a trigger and a second stop portion disposed on the trigger, and the first stop portion and the second stop portion mate with each other so that the directional member locks the trigger at the startup position.

In some examples, the directional member is disposed on the housing and rotatable relative to the housing.

In some examples, the first stop portion includes a protrusion disposed on the directional member and extending toward the trigger, the second stop portion includes a groove disposed on the trigger and opened toward the directional member, and when the trigger is at the startup position and the protrusion is inserted into the groove, the directional member locks the trigger at the startup position.

In some examples, when the trigger is at the startup position, a surface of the groove abutting against the protrusion is an arc-shaped surface.

In some examples, the directional member is disposed above the trigger and switchable between a forward rotation position, a reverse rotation position, and a locking position, when the directional member is at the locking position, the protrusion is inserted into the groove, and when the directional member is at the forward rotation position and the reverse rotation position, the protrusion is removed from the groove.

In some examples, when the directional member is at the forward rotation position and the reverse rotation position, the directional member unlocks the trigger.

In some examples, the power tool further includes a first elastic member disposed between the trigger and the housing, where when the directional member is at the forward rotation position and the reverse rotation position, the first elastic member causes the trigger to return to the shutdown position.

In some examples, a dust shield is sleeved on the outer circumference of the first elastic member.

In some examples, the forward rotation position and the reverse rotation position are located on the left and right sides of the locking position one to one, the trigger is provided with a slide slot on each of the left and right sides of the groove, the left and right sides of the groove each communicate with a corresponding slide slot, and when the directional member is at the forward rotation position and the reverse rotation position, the protrusion is slidable in a corresponding slide slot.

In some examples, the slide slot includes a sidewall for stopping the protrusion, and when the trigger is at the shutdown position, the sidewall prevents the directional member from moving from the forward rotation position or the reverse rotation position to the locking position.

In some examples, when the directional member moves to the forward rotation position, a forward rotation circuit of the power tool is connected so that the electric motor keeps rotating forward when the trigger is at the startup position.

In some examples, the power tool includes a forward rotation trigger element, the forward rotation trigger element is triggered when the directional member moves to the forward rotation position, and after triggered, the forward rotation trigger element sends a forward rotation signal to a controller of the power tool, and the controller controls the forward rotation circuit to be connected and keeps the forward rotation circuit connected.

In some examples, when the directional member moves to the reverse rotation position, a reverse rotation circuit of the power tool is connected so that the electric motor keeps rotating reversely when the trigger is at the startup position.

In some examples, the power tool includes a reverse rotation trigger, the reverse rotation trigger is triggered when the directional member moves to the reverse rotation position, and after triggered, the reverse rotation trigger sends a reverse rotation signal to a controller of the power tool, and the controller controls the reverse rotation circuit to be connected and keeps the reverse rotation circuit connected.

In some examples, an operating method for a power tool is provided. The power tool includes an electric motor, a switch assembly for a user to operate to switch between a startup position and a shutdown position, and a directional assembly for the user to operate to control a rotation direction of the electric motor, where the switch assembly at the startup position sends a startup signal to the electric motor, and the switch assembly at the shutdown position sends a shutdown signal to the electric motor. The operating method includes the step below.

When the switch assembly is at the startup position and the directional assembly mates with the switch assembly to lock the switch assembly at the startup position, the directional assembly is operated to unlock the switch assembly.

When the directional assembly unlocks the switch assembly, the switch assembly switches to the shutdown position.

In some examples, the directional assembly includes a directional member and a first stop portion disposed on the directional member, the switch assembly includes a trigger and a second stop portion disposed on the trigger, and when the switch assembly is locked at the startup position, the first stop portion and the second stop portion are operated to mate with each other.

In some examples, the first stop portion includes a protrusion disposed on the directional member and extending toward the trigger, and the second stop portion includes a groove disposed on the trigger and opened toward the directional member.

In some examples, when the switch assembly is locked at the startup position, the protrusion is operated to be inserted into the groove.

In some examples, the trigger is provided with a slide slot on each of the left and right sides of the groove, the left and right sides of the groove each communicate with a corresponding slide slot, and when the directional assembly unlocks the switch assembly, the protrusion is operated to move into the slide slot.

### BRIEF DESCRIPTION OF THE DRAWINGS

FIG. 1 is a structural view of a power tool according to an example.

FIG. 2 is a view illustrating the internal structure of the power tool of FIG. 1.

FIG. 3 is a sectional view of the power tool of FIG. 1.

FIG. 4 is a structural view of a switch assembly and a directional assembly according to an example, where the switch assembly is at a shutdown position.

FIG. 5 is a structural view of a switch assembly and a directional assembly according to an example, where the switch assembly is at a startup position.

FIG. 6 is a top view of the switch assembly and the directional assembly of FIG. 5.

FIG. 7 is a structural view of a linkage switch according to an example.

FIG. 8 is a structural view of a fixing assembly and a trigger in a power tool according to an example.

FIG. 9 is a structural view of a button in the power tool of FIG. 8.

FIG. 10 is a structural view of the power tool of FIG. 8, with the trigger at a startup position and a button not pressed.

FIG. 11 is a structural view of the power tool of FIG. 8, with the trigger at a startup position and a button pressed.

FIG. 12 is an enlarged view of part A of FIG. 11.

FIG. 13 is a structural view of the power tool of FIG. 8, with the trigger at a startup position and a button pressed and screwed.

FIG. 14 is a structural view of the power tool of FIG. 8, with the trigger at a startup position and a first fixing member mating with a first stop member.

FIG. 15 is an enlarged view of part B of FIG. 14.

FIG. 16 is a perspective view of a power tool according to an example.

FIG. 17 is a perspective view of an electric motor according to an example.

FIG. 18 is an exploded view of the electric motor of FIG. 17.

FIG. 19 is a top view of an electric motor according to an example.

FIG. 20 is a perspective view of an electric motor including a third fixing structure according to an example.

FIG. 21 is a perspective view of the electric motor of FIG. 20 excluding the third fixing structure.

FIG. 22 is a sectional view of the electric motor of FIG. 20 including a limiting groove.

FIG. 23 is a perspective view of a second fixing structure of an electric motor according to an example, where the second fixing structure includes a first accommodation space and a second accommodation space.

FIG. 24 is an enlarged view of part M of the electric motor of FIG. 23.

FIG. 25 is a side view of the electric motor of FIG. 23.

FIG. 26 is a bottom view of the electric motor of FIG. 25 along a cross section C.

FIG. 27 is a top view of the electric motor of FIG. 25 along a cross section D.

FIG. 28 is a perspective view of a second fixing structure of an electric motor according to an example, where the second fixing structure includes a first limiting component.

FIG. 29 is a side view of the electric motor of FIG. 28.

FIG. 30 is a top view of a second fixing structure of an electric motor according to an example, where the second fixing structure includes second limiting components.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

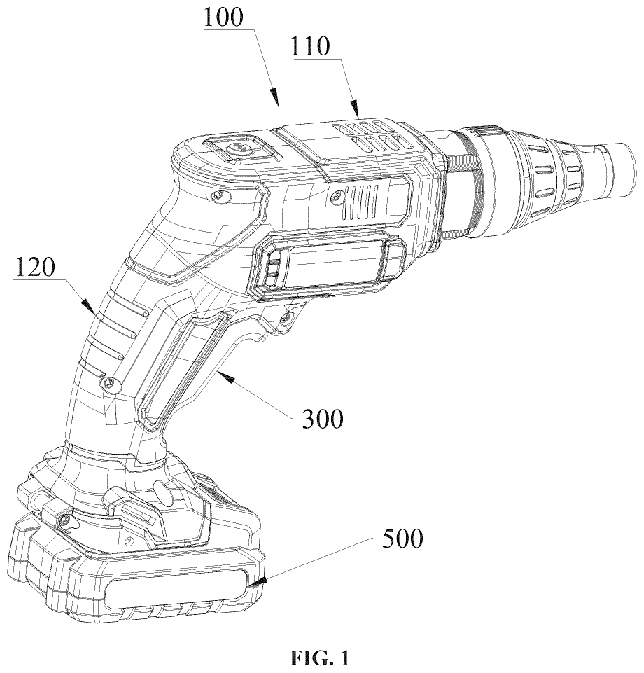

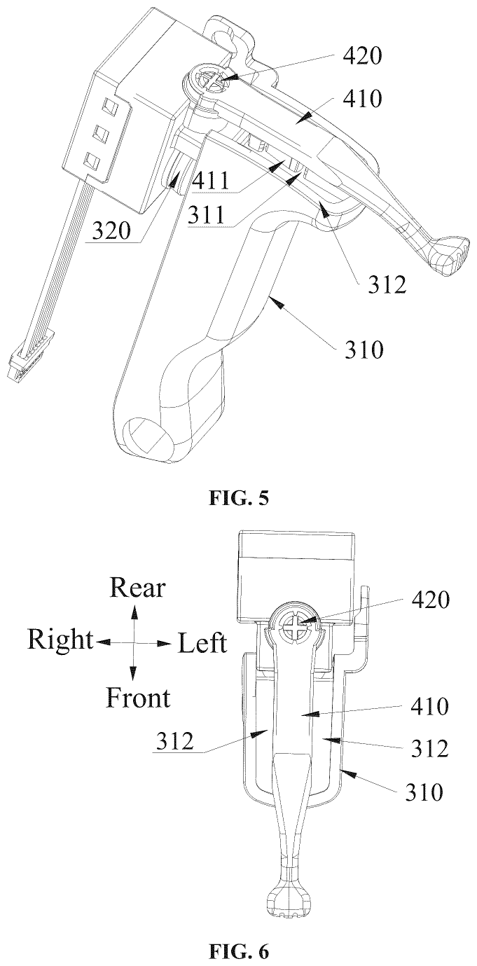

As shown in FIGS. 1 to 7, this example provides a power tool. In this example, the power tool may be an electric screwdriver. In other examples, the power tool may be other tools that rotate forward and reversely. The power tool includes a housing 100, an electric motor 200, and a switch assembly 300. The electric motor 200 is disposed at least partially in the housing 100 and includes a rotating shaft 210 rotatable about a first axis 211. The switch assembly 300 is for a user to operate to switch between a startup position and a shutdown position, where the switch assembly 300 at the startup position sends a startup signal to the electric motor 200, and the switch assembly 300 at the shutdown position sends a shutdown signal to the electric motor 200. The power tool further includes a directional assembly 400. The directional assembly 400 is for the user to operate to control a rotation direction of the electric motor 200. The directional assembly 400 is further configured to mate with the switch assembly 300 to lock the switch assembly 300 at the startup position. In other words, the directional assembly 400 is further configured to mate with the switch assembly 300 to lock the switch assembly 300 so that the switch assembly 300 is maintained at the startup position. When the directional assembly 400 is operated to be disengaged from the switch assembly 300 to unlock the switch assembly 300, the switch assembly 300 switches to the shutdown position.

With the above arrangement, even if the switch assembly 300 is touched by accident in a working process, the switch assembly 300 does not change in position since the switch assembly 300 is locked by the directional assembly 400, and thus a working state of the power tool does not change so that the reliability with which the switch assembly 300 is locked is improved, and the rotation process of the electric motor 200 has relatively good reliability, thereby improving the work efficiency and quality.

In some examples, the directional assembly 400 includes a directional member 410 and a first stop portion 411 disposed on the directional member 410, the switch assembly 300 includes a trigger 310 and a second stop portion 311 disposed on the trigger 310, and the first stop portion 411 and the second stop portion 311 mate with each other so that the directional member 410 locks the trigger 310 at the startup position. The above structures are disposed so that the trigger 310 at the startup position is locked, and the trigger 310 is prevented from moving from the startup position to the shutdown position, enabling the power tool to remain in a rotating state.

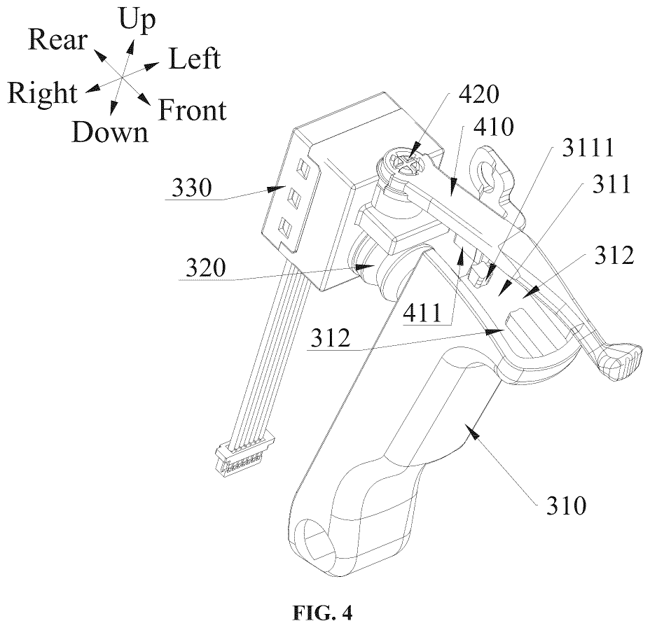

As shown in FIGS. 4 to 6, regarding specific mating structures of the first stop portion 411 and the second stop portion 311, in some examples, the first stop portion 411 includes a protrusion disposed on the directional member 410 and extending toward the trigger 310, the second stop portion 311 includes a groove disposed on the trigger 310 and opened toward the directional member 410, and when the trigger 310 is at the startup position and the protrusion is inserted into the groove, the directional member 410 locks the trigger 310 at the startup position. The protrusion and the groove are disposed so that the trigger 310 at the startup position is locked. Moreover, the protrusion and the groove are simple in structure, easy to produce, and convenient to operate.

Regarding a relative position relationship between the directional member 410 and the trigger 310, in some examples, the directional member 410 is disposed above the trigger 310 and switchable between a forward rotation position, a reverse rotation position, and a locking position, when the directional member 410 is at the locking position, the protrusion is inserted into the groove, and when the directional member 410 is at the forward rotation position and the reverse rotation position, the protrusion is removed from the groove. Specifically, the protrusion extends downward, the groove is opened upward, and the trigger 310 moves in a front and rear direction. With the above arrangement, after the protrusion is inserted into the groove, a sidewall of the groove and a sidewall of the protrusion abut against each other so that the trigger 310 at the startup position is locked, and the trigger 310 is prevented from moving to the shutdown position. Thus, in a normal working process, even if the trigger 310 is touched by accident, the trigger 310 does not change in position so that the reliability with which the trigger 310 is locked is improved, and the rotation process of the electric motor 200 has relatively good reliability, thereby improving the work efficiency and quality.

The directional member 410 is disposed on the housing 100 and rotates relative to the housing 100. The directional member 410 includes a rotating end and an operating end. The rotating end is provided with a rotating hole, and a fixing screw 420 penetrates through the rotating hole and is screwed to the housing 100. The operating end is for the user to operate to toggle the directional member 410 between the forward rotation position, the reverse rotation position, and the locking position. To ensure the stability of the directional member 410 at a certain position, the directional member 410 has damping during rotation.

When the directional member 410 is at the forward rotation position and the reverse rotation position, the directional member 410 unlocks the trigger 310. In this state, the trigger 310 can return to the shutdown position under the action of a resilient force or can be manually operated by the user to the shutdown position. In this example, a first elastic member 320 is disposed between the trigger 310 and the housing 100. When the trigger 310 is moved to the startup position under an external force, the first elastic member 320 is compressed and stores energy. When the external force disappears, the first elastic member 320 can apply the resilient force to the trigger 310 so that the trigger 310 moves to the shutdown position. The first elastic member 320 may be a spring. A dust shield is sleeved on the outer circumference of the spring to prevent impurities from falling into an interstice of the spring and affecting the normal compression of the spring, thereby facilitating the smooth switching of the trigger 310 between the startup position and the shutdown position.

In some examples, the forward rotation position and the reverse rotation position are located on left and right sides of the locking position one to one, the trigger 310 is provided with a slide slot 312 on each of the left and right sides of the groove, the left and right sides of the groove each communicate with a corresponding slide slot 312, and when the directional member 410 is at the forward rotation position and the reverse rotation position, the protrusion is slidable in a corresponding slide slot 312. For example, a specific description is provided in the present application by using an example in which the forward rotation position is located on the left side of the locking position and the reverse rotation position is located on the right side of the locking position. For example, when the directional member 410 is at the forward rotation position, the protrusion is in the slide slot 312 on the left side of the groove. In this state, the trigger 310 can move between the startup position and the shutdown position, and in the process of the trigger 310 moving between the startup position and the shutdown position, the protrusion guides the slide slot 312 to a certain extent. Regarding the communication of the groove with slide slots 312 on two sides, a left channel and a right channel are provided on the left and right sides of the groove respectively, and the groove communicates with one slide slot 312 through the left channel and communicates with the other slide slot 312 through the right channel. With the above arrangement, the directional member 410 at the locking position is toggled leftward so that the directional member 410 can be moved to the forward rotation position, and the directional member 410 at the locking position is toggled rightward so that the directional member 410 can be moved to the reverse rotation position. In specific use, if the trigger 310 is required to move to the shutdown position and the electric motor 200 is required to rotate forward during the next operation, the directional member 410 is toggled leftward to the forward rotation position. If the trigger 310 is required to move to the shutdown position and the electric motor 200 is required to rotate reversely during the next operation, the directional member 410 is toggled rightward to the reverse rotation position.

Additionally, the slide slot 312 is disposed so that when the trigger 310 is at the shutdown position, a sidewall of the slide slot 312 stops the protrusion, that is, the directional member 410 can neither move from the forward rotation position to the locking position nor move from the reverse rotation position to the locking position.

In other examples, the specific setting of the forward rotation position and the reverse rotation position may be opposite to that in the preceding case, that is, the forward rotation position may be located on the right side of the locking position and the reverse rotation position may be located on the left side of the locking position. Specifically, the forward rotation position and the reverse rotation position may be reasonably set according to the habits of the user.

When the directional member 410 locks the trigger 310 at the startup position, a surface of the groove abutting against the protrusion is an arc-shaped surface 3111, and the protrusion is in contact with the bottom of the arc-shaped surface 3111. When the protrusion is located in the groove, that is, when the directional member 410 is at the locking position, if the directional member 410 is required to move to the forward rotation position or the reverse rotation position, a sidewall of the arc-shaped surface 3111 blocks the movement and has certain resistance. In the process of forcibly toggling the directional member 410, the trigger 310 moves toward the housing 100 and compresses the first elastic member 320 so that the protrusion goes across the sidewall of the arc-shaped surface 3111. The above arrangement improves the stability of the directional member 410 at the locking position.

In some examples, when the directional member 410 moves to the forward rotation position, a forward rotation circuit of the power tool is connected so that the electric motor 200 keeps rotating forward when the trigger 310 is at the startup position. The above arrangement limits a manner in which the forward rotation circuit is connected, which is simple to operate and is conducive to improving the work efficiency.

Specifically, the power tool includes a forward rotation trigger element. The forward rotation trigger element is triggered when the directional member 410 moves to the forward rotation position. After triggered, the forward rotation trigger element sends a forward rotation signal to a controller of the power tool, and the controller controls the forward rotation circuit to be connected and keeps the forward rotation circuit connected. With the above arrangement, on the basis that the forward rotation circuit is connected, the electric motor 200 can be started and rotate forward when the trigger 310 is moved to the startup position. The forward rotation trigger element may be a photoelectric sensor or a microswitch. In other examples, the forward rotation trigger element may be other structures that can trigger a signal in the existing art. With the above structural setting, after the forward rotation trigger element is triggered, the forward rotation circuit remains connected. In this state, even if the directional member 410 is moved to the locking position in the subsequent operating process, it can be ensured that the forward rotation circuit is connected so that the electric motor 200 remains in a working state of rotating forward. With the above arrangement, during the forward rotation of the electric motor 200, the directional member 410 is not necessarily maintained at the forward rotation position. It is to be noted that a manner and a specific working principle of the controller controlling the forward rotation circuit to be connected and keeping the forward rotation circuit connected are well-known to those skilled in the art and thus are not described in detail here.

In some examples, when the directional member 410 moves to the reverse rotation position, a reverse rotation circuit of the power tool is connected so that the electric motor 200 keeps rotating reversely when the trigger 310 is at the startup position. The above arrangement limits a manner in which the reverse rotation circuit is connected, which is simple to operate and is conducive to improving the work efficiency.

Specifically, the power tool includes a reverse rotation trigger. The reverse rotation trigger is triggered when the directional member 410 moves to the reverse rotation position. After triggered, the reverse rotation trigger sends a reverse rotation signal to the controller of the power tool, and the controller controls the reverse rotation circuit to be connected and keeps the reverse rotation circuit connected. With the above arrangement, on the basis that the reverse rotation circuit is connected, the electric motor 200 can be started and rotate reversely when the trigger 310 is moved to the startup position. The reverse rotation trigger may be a photoelectric sensor or a microswitch. In other examples, the reverse rotation trigger may be other structures that can trigger a signal in the existing art. With the above structural setting, after the reverse rotation trigger is triggered, the reverse rotation circuit remains connected. In this state, even if the directional member 410 is moved to the locking position in the subsequent operating process, it can be ensured that the reverse rotation circuit is connected so that the electric motor 200 remains in a working state of rotating reversely. With the above arrangement, during the reverse rotation of the electric motor 200, the directional member 410 is not necessarily maintained at the reverse rotation position. It is to be noted that a manner and a specific working principle of the controller controlling the reverse rotation circuit to be connected and keeping the reverse rotation circuit connected are well-known to those skilled in the art and thus are not described in detail here.

This example further provides an operating method for a power tool. The power tool includes an electric motor 200, a switch assembly 300 for a user to operate to switch between a startup position and a shutdown position, and a directional assembly 400 for the user to operate to control a rotation direction of the electric motor 200. The switch assembly 300 at the startup position sends a startup signal to the electric motor 200. The switch assembly 300 at the shutdown position sends a shutdown signal to the electric motor 200. The operating method includes: when the switch assembly 300 is at the startup position and the directional assembly 400 mates with the switch assembly 300 to lock the switch assembly 300 at the startup position, operating the directional assembly 400 to unlock the switch assembly 300. When the directional assembly 400 unlocks the switch assembly 300, the switch assembly 300 switches to the shutdown position.

With the limitation of the above method, in the normal working process of the power tool, even if the switch assembly 300 is touched by accident, the switch assembly 300 does not move to the shutdown position due to the locking of the directional assembly 400 so that the electric motor 200 remains in a normal working state, facilitating an improvement of the work efficiency and quality.

Regarding the structure of the power tool, specifically, the housing 100 of the power tool includes a housing body 110 and a grip 120 disposed on a side of the housing body 110, an output shaft 220 rotating about a second axis 221 is disposed in the housing body 110, and the output shaft 220 is drivingly connected to the rotating shaft 210 by a transmission member. A battery 500 is disposed at the bottom of the grip 120. The battery 500 is electrically connected to the electric motor 200 to provide electrical energy for the rotation of the electric motor 200.

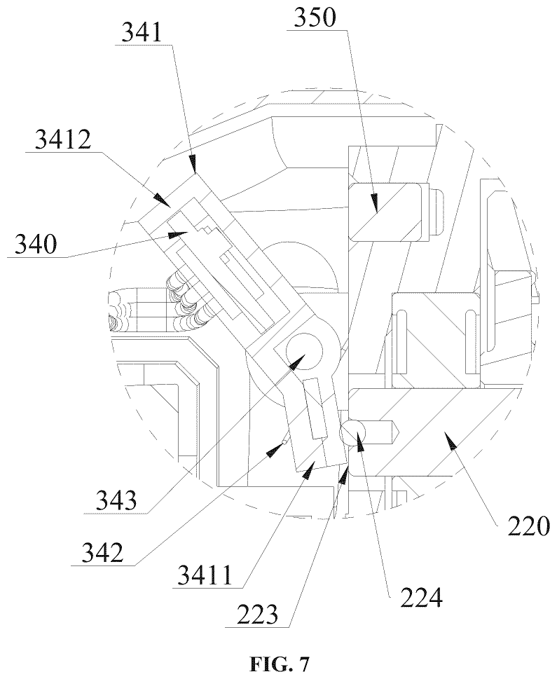

As shown in FIG. 7, the power tool further includes a linkage switch. The switch assembly 300 is disposed near the grip 120 and configured to send the startup signal and the shutdown signal to the motor when manually operated by the user. The linkage switch is disposed in the housing 100, and a signal of the linkage switch responds to a motion state of the output shaft 220. In this example, the switch assembly 300 is connected in series with the signal of the linkage switch.

The switch assembly 300 includes the trigger 310 and a switching element 330 connected to the trigger 310. The trigger 310 is configured to receive an operating instruction from the user. Generally speaking, when the trigger 310 is activated, the switching element 330 is on, and when the trigger 310 is not activated, the switching element 330 is off. In this example, the user inputs operating instructions by pressing and releasing the trigger 310. In some alternative examples, the user inputs operating instructions to the trigger 310 through operations such as rotation, toggling, or touching. In this example, the trigger 310 is activated when moved to the startup position, and the trigger 310 is not activated when moved to the shutdown position.

The linkage switch includes a detection element 340 and an activation element 350. The detection element 340 is coupled to the electric motor 200, and the activation element 350 is configured to activate the detection element 340. In this example, the activation element 350 activates the detection element 340 in response to a motion of the output shaft 220. In a motion process, the detection element 340 includes an activated state in which the detection element 340 is activated by the activation element 350 to generate an activation signal and a sleep state in which the detection element 340 is not activated by the activation element 350. In this example, when the detection element 340 is in the activated state and the switch assembly 300 is in an on state, the electric motor 200 is started. That is, the electric motor 200 cannot be started when the detection element 340 is in the sleep state or the switch assembly 300 is in an off state. It is to be noted that the output shaft 220 drives the detection element 340 to move, which may be understood as that the output shaft 220 directly drives the detection element 340 to translate, rotate, slide, or move in another manner or that the output shaft 220 indirectly drives the detection element 340 to translate, rotate, slide, or move in another manner. In this example, the output shaft 220 drives the detection element 340 to rotate about a detection axis, and during rotation, the detection element 340 can be activated by the activation element 350 to be in the activated state.

In this example, the output shaft 220 drives the detection element 340 to rotate. For example, when an input end 222 of the output shaft 220 receives a force to move along the second axis 221 so that an output end 223 of the output shaft 220 moves backward along the second axis 221, the output end 223 can drive the detection element 340 to rotate about the detection axis.

In this example, the linkage switch further includes a rotating member 341, a biasing member 342, and a connector 343, where the rotating member 341 is rotatably connected to the housing 100 through the connector 343. The rotating member 341 is used for mounting the detection element 340, which may be understood as that the output shaft 220 drives the rotating member 341 to rotate about the detection axis to drive the detection element 340 to rotate. The connector 343 is rod-shaped, and the detection axis is an axis of the connector 343. The biasing member 342 is mounted on the rotating member 341. For example, when mounted, the biasing member 342 has a biasing force. The biasing force can keep the rotating member 341 at an initial position when no external force is applied. In this example, the rotating member 341 includes a connecting portion 3411 and a mounting portion 3412. The mounting portion 3412 is formed with an accommodation slot, and the detection element 340 is mounted in the accommodation slot and rotates synchronously with the rotating member 341. The connecting portion 3411 is fixedly connected to or integrally formed with the mounting portion 3412. For example, the connecting portion 3411 is integrally formed with the mounting portion 3412. The biasing member 342 can provide the biasing force that keeps the detection element 340 at an initial position without the drive of an external force. That is to say, the biasing member 342 keeps the detection element 340 at the initial position in the case where the output shaft 220 is driven by no external force. On the premise that the switch assembly 300 is always in the on state, when the input end 222 receives the force to move toward the rotating shaft 210 along the first axis 211, the output end 223 can drive the detection element 340 to switch from the sleep state to the activated state. When the detection element 340 is in the sleep state, the output end 223 is at least partially in contact with the connecting portion 3411. That is to say, when the detection element 340 is in the activated state, the detection element 340 is at least partially in contact with the activation element 350. A driving member 224 is disposed on the output shaft 220. The driving member 224 may drive the connecting portion 3411 to cause the detection element 340 to rotate. The driving member 224 may be a ball. With the above arrangement, when the electric motor 200 drives the output shaft 220 to run at a high speed, the connecting portion 3411 can be prevented from damage, thereby prolonging the service life. In this example, the detection element 340 is a Hall sensor, and the activation element 350 is a permanent magnet. It is to be noted that the output end 223 may be formed by the driving member 224.

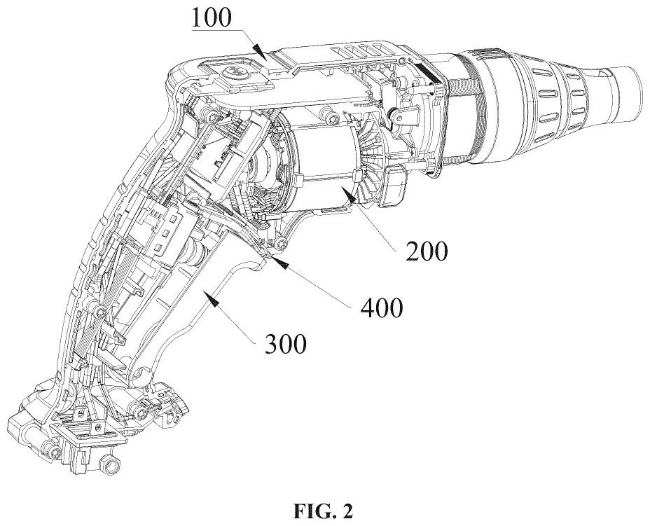

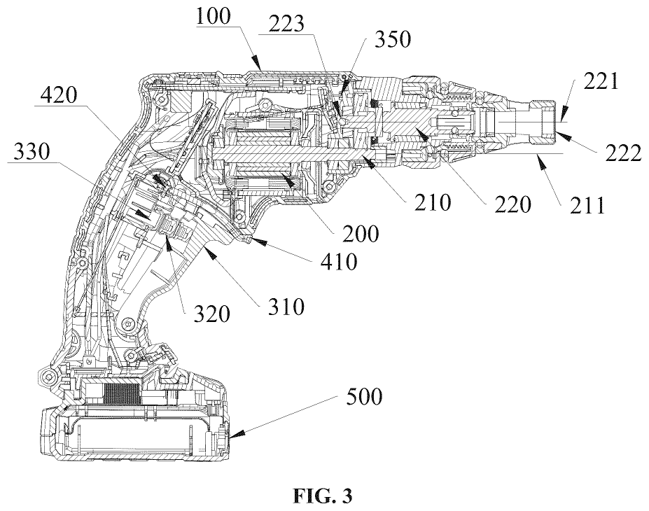

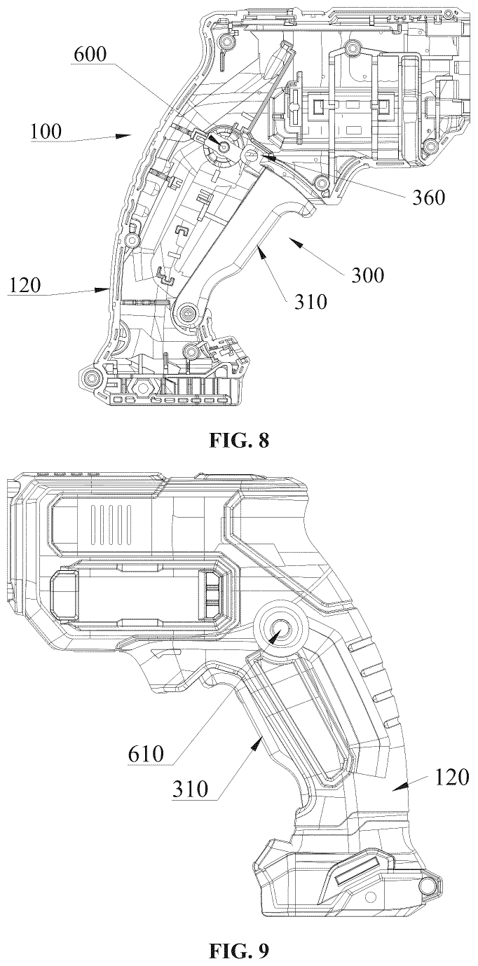

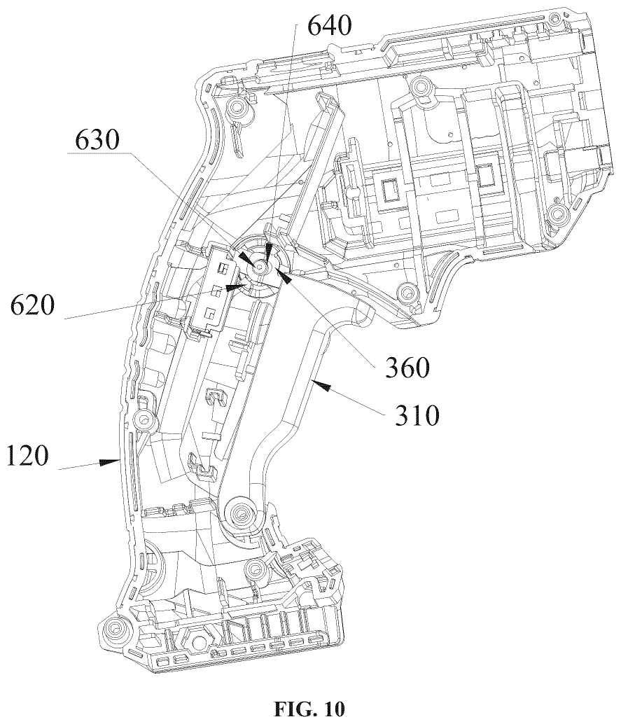

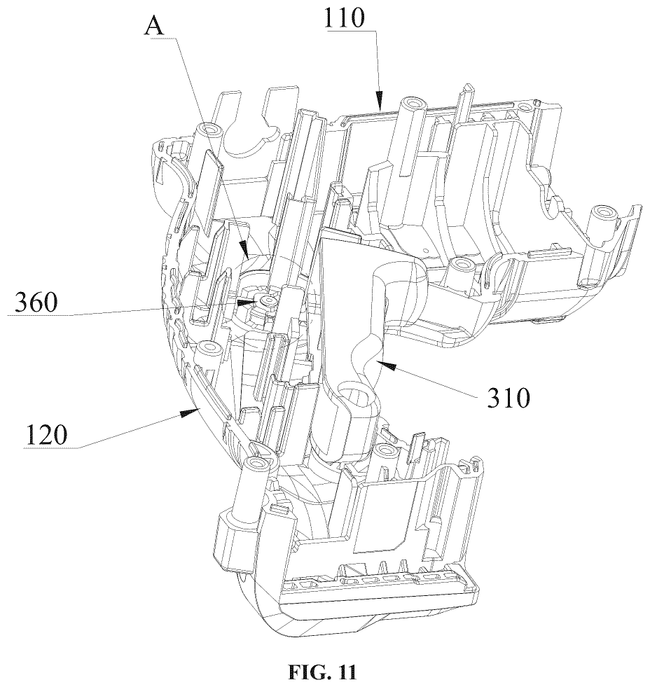

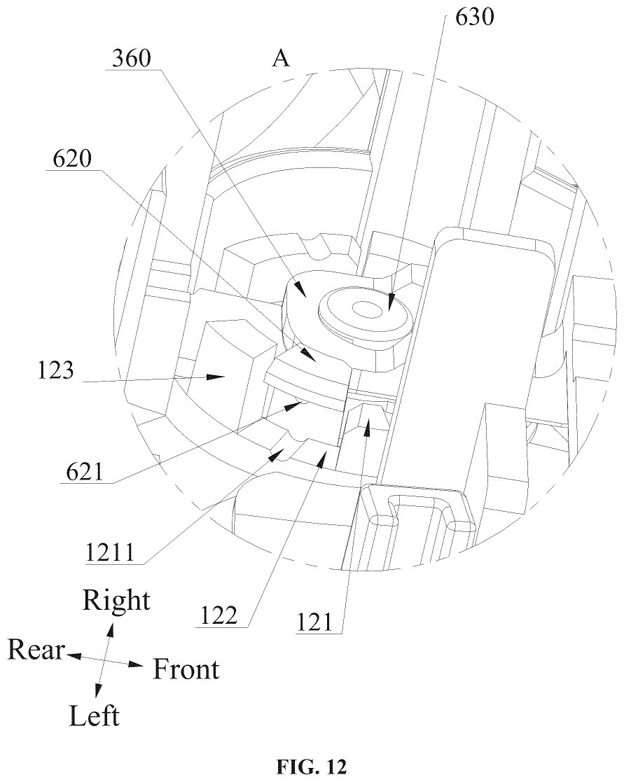

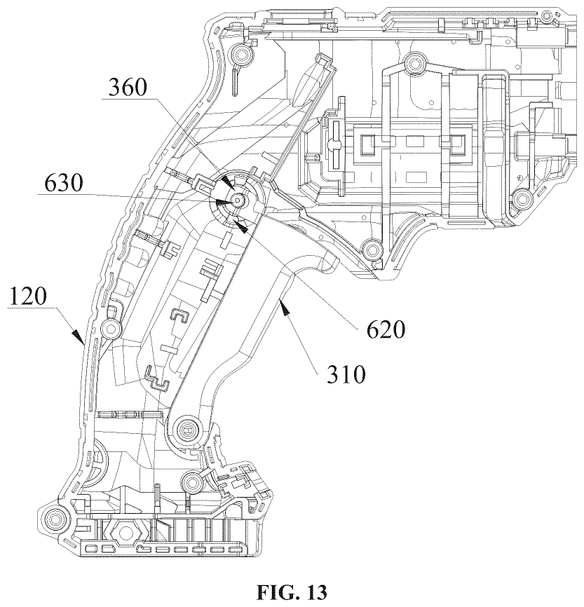

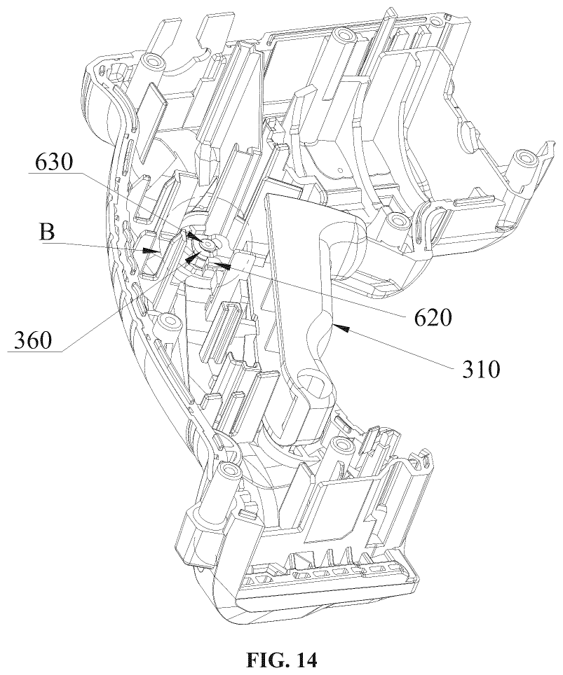

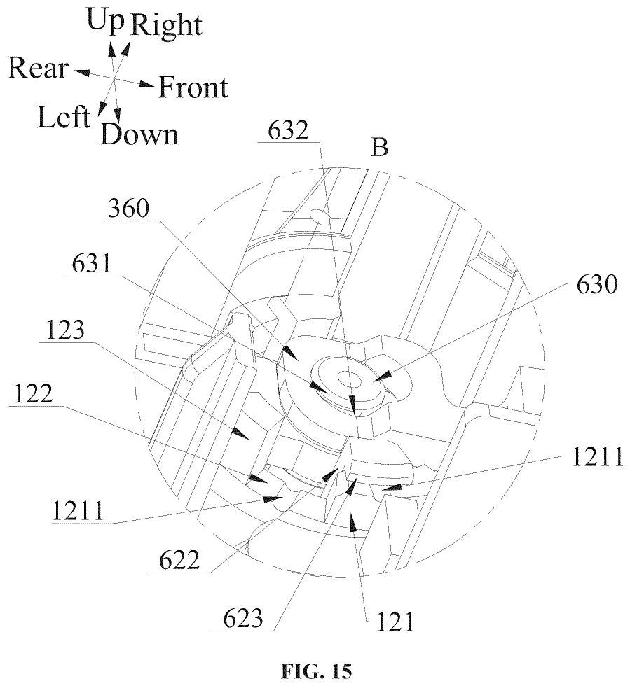

As shown in FIGS. 8 to 15, this example provides a power tool. In this example, the power tool includes a housing 100, an electric motor 200, a switch assembly 300, and a fixing assembly 600. The electric motor 200 is disposed at least partially in the housing 100. The electric motor 200 includes a rotating shaft 210 rotatable about a first axis 211. The structures of and a position relationship between the electric motor 200, the first axis 211, and the rotating shaft 210 are the same as those shown in FIGS. 2 and 3. The switch assembly 300 is for a user to operate to switch between a startup position and a shutdown position. The fixing assembly 600 includes a button 610 and a first fixing member 620. The button 610 is connected to the first fixing member 620. The button 610 is disposed on the outer side of the housing 100, and the first fixing member 620 is disposed on the inner side of the housing 100. A first stop member 121 is included on the inner side of the housing 100 and matched with the first fixing member 620. When the switch assembly 300 is at the startup position and the switch assembly 300 mates with the fixing assembly 600, the button 610 is rotated so that the first fixing member 620 mates with the first stop member 121 to lock the switch assembly 300 at the startup position.

In this example, with the above arrangement of the fixing assembly 600 in the power tool, when the electric motor 200 of the power tool rotates, even if a trigger 310 is touched by accident, the fixing assembly 600 is not triggered to rotate. Thus, the fixing assembly 600 does not change in position, and the trigger 310 is not unlocked so that the reliability with which the trigger 310 is locked is improved, and the rotation process of the electric motor 200 has relatively good reliability, thereby improving the work efficiency and quality.

When the power tool is in normal use, the electric motor 200 is in a rotating state. In this process, under the action of slight disturbance or vibration, the first stop member 121 and the first fixing member 620 are likely to rotate relative to each other. Thus, the first stop member 121 and the first fixing member 620 are disengaged from each other, and the switch assembly 300 returns to the shutdown position. To solve the above problem, in some examples, the first stop member 121 is provided with a recessed portion 1211 and the first fixing member 620 is provided with a raised portion 621, or the first stop member 121 is provided with the raised portion 621 and the first fixing member 620 is provided with the recessed portion 1211, where the raised portion 621 is inserted into the recessed portion 1211 to prevent the button 610 from being rotated. With the arrangement of the above structures, when the first stop member 121 mates with the first fixing member 620, the raised portion 621 is inserted into the recessed portion 1211 so that under the action of slight disturbance or vibration, the first stop member 121 and the first fixing member 620 cannot rotate relative to each other. Thus, the first stop member 121 and the first fixing member 620 remain in a state of mating with each other, thereby ensuring that the switch assembly 300 is locked at the startup position.

Regarding the specific structure of the raised portion 621, in some examples, the raised portion 621 is a hemispherical structure and protrudes out from the first fixing member 620, and the shape of the recessed portion 1211 adapts to that of the raised portion 621. When the user screws the button 610, the raised portion 621 can be screwed out of the recessed portion 1211. The button 610 continues to be screwed to drive the first fixing member 620 to rotate relative to the first stop member 121 so that the first fixing member 620 and the first stop member 121 are disengaged from each other, and the switch assembly 300 can move to the shutdown position.

Further, the first fixing member 620 includes a rod-shaped portion 622 and a crimp portion 623 connected to each other, where the rod-shaped portion 622 is connected to the button 610. When the first fixing member 620 mates with the first stop member 121, the crimp portion 623 is crimped to the first stop member 121. The button 610 is a columnar member. In an axial direction of the button 610, that is, in a left and right direction of the power tool, the length of the rod-shaped portion 622 is the same as the length of the first stop member 121. When the first stop member 121 mates with the first fixing member 620, the first stop member 121 prevents the first fixing member 620 from moving toward the button 610, that is, prevents the first fixing member 620 from moving to the left side of the power tool. With the above arrangement, when the first fixing member 620 mates with the first stop member 121, the first fixing member 620 cannot change in position under the limiting action of the first stop member 121, and the fixing assembly 600 keeps the switch assembly 300 in a locked state.

The crimp portion 623 is disposed at an end of the rod-shaped portion 622 and extends in a direction perpendicular to an axis of the rod-shaped portion 622. The first stop member 121 is integrally formed with the housing 100. The first stop member 121 is disposed on the circumferential side of an axis of the button 610 and extends along a direction of the axis of the button 610. In other words, the first stop member 121 extends along the left and right direction of the power tool.

Regarding a manner in which the fixing assembly 600 limits the switch assembly 300, in this example, the fixing assembly 600 further includes a second fixing member 630, where the second fixing member 630 is connected to the button 610. The switch assembly 300 includes a stop 360. When the switch assembly 300 is at the startup position, the button 610 is pressed to cause the second fixing member 630 to mate with the stop 360 so that the switch assembly 300 is prevented from moving to the shutdown position.

To avoid the case where the second fixing member 630 is disengaged from the switch assembly 300 to unlock the switch assembly 300 when the switch assembly 300 is locked, in this example, an engaging portion 631 extends radially at an end of the second fixing member 630 facing away from the button 610, the second fixing member 630 mates with the stop 360, and when the switch assembly 300 loses an external force, the engaging portion 631 is engaged on a side of the stop 360 facing away from the button 610. With the above arrangement, the engaging portion 631 and the switch assembly 300 can be engaged with each other so that only after the engaging portion 631 is disengaged from the switch assembly 300 in such manner that the button 610 is rotated to drive the second fixing member 630 to rotate, can the button 610 be away from the switch assembly 300 and the second fixing member 630 be disengaged from the switch assembly 300.

Specifically, the stop 360 includes a circular ring, and the second fixing member 630 is a columnar member. When the switch assembly 300 is at the startup position, the button 610 is pressed to cause the second fixing member 630 to be matched with and inserted into the circular ring.

The circular ring is disposed on the trigger 310. Optionally, the circular ring is integrally formed with the trigger 310. Optionally, the circular ring is separate from the trigger 310 and fixedly connected to the trigger 310. The circular ring has a channel, and the channel mates with the second fixing member 630 and is through along the left and right direction. In an up and down direction of the power tool, the length of the channel is greater than the diameter of the second fixing member 630. With the above arrangement, after screwing, the engaging portion 631 moves from the rear side of an axis of the second fixing member 630 to the upper side or the lower side of the axis of the second fixing member 630 to be disengaged from the circular ring. In this state, the second fixing member 630 can be pulled out from the circular ring. Regarding the formation of the engaging portion 631, in some examples, the second fixing member 630 is provided with an engaging groove 632, and a portion between the upper sidewall of the engaging groove 632 and the top of the second fixing member 630 forms the engaging portion 631. Specifically, the button 610 is screwed clockwise to drive the engaging portion 631 to move from the rear side of the axis of the second fixing member 630 to the upper side of the axis of the second fixing member 630 to be disengaged from the circular ring. In this state, the second fixing member 630 can move to the left and be pulled out from the circular ring.

The button 610 moves between an initial position and a locking position. When a second stop member 122 mates with the first fixing member 620, the initial position of the fixing assembly 600 is defined. When the first stop member 121 mates with the first fixing member 620, the locking position of the fixing assembly 600 is defined. The second stop member 122 is included on the inner side of the housing 100. The second stop member 122 mates with the first fixing member 620. Specifically, before the button 610 is rotated, the second stop member 122 mates with the first fixing member 620. With the above arrangement, the initial position of the button 610 is specifically defined, making it convenient for the user to control the specific position of the button 610. Additionally, the above arrangement can prevent the fixing assembly 600 from being separated from the housing 100.

To pull the second fixing member 630 out from the circular ring, in some examples, the first fixing member 620 includes the rod-shaped portion 622 and the crimp portion 623 connected to each other, where the rod-shaped portion 622 is connected to the button 610. When the first fixing member 620 mates with the second stop member 122, the crimp portion 623 is crimped to the second stop member 122, and in the left and right direction, the length of the rod-shaped portion 622 is greater than the length of the second stop member 122. When the second stop member 122 mates with the first fixing member 620, the switch assembly 300 can switch between the shutdown position and the startup position. With the above arrangement, when the first fixing member 620 is rotated to be disengaged from the first stop member 121, the engaging portion 631 on the second fixing member 630 rotates from the rear side of the axis of the second fixing member 630 to the upper side or the lower side of the axis of the second fixing member 630 so that when the button 610 is away from the housing 100, the second fixing member 630 can be pulled out from the circular ring, and the first fixing member 620 abuts against and mates with the second stop member 122. The second stop member 122 is also provided with the recessed portion 1211.

Specifically, the second stop member 122 is integrally formed with the housing 100. The second stop member 122 is disposed on the circumferential side of the axis of the button 610 and extends along the direction of the axis of the button 610. The second stop member 122 and the first stop member 121 are spaced apart around the axis of the button 610. The button 610 is coaxial with the second fixing member 630. A limiting member 123 is further provided inside the housing 100. The limiting member 123 is disposed on a side of the button 610 and on a side of the second stop member 122 facing away from the first stop member 121. The limiting member 123, the second stop member 122, and the first stop member 121 form a limiting groove, where the top of the second stop member 122 forms the bottom of the limiting groove. The crimp portion 623 at the initial position is located in the limiting groove and abuts against the bottom of the limiting groove.

In this example, the crimp portion 623 protrudes from the rod-shaped portion 622 in a direction in which the rod-shaped portion 622 is away from the second fixing member 630.

When the first fixing member 620 is disengaged from the first stop member 121, to ensure that the button 610 can automatically return to the initial position and improve the reset efficiency of the button 610, in some examples, the fixing assembly 600 includes a second elastic member 640, where the second elastic member 640 is disposed between the housing 100 and the button 610 and configured to apply a resilient force to the button 610 to make the button 610 away from the housing 100.

The second elastic member 640 is a spring. The spring is sleeved on the second fixing member 630, with one end abutting against the button 610 and the other end abutting against the housing 100, so that the button 610 can move away from the housing 100.

When the switch assembly 300 is at the startup position and the switch assembly 300 mates with the fixing assembly 600, the button 610 is rotated to disengage the first fixing member 620 from the first stop member 121 so that the fixing assembly 600 resets to the initial position and unlocks the switch assembly 300. The above arrangement defines the relative position relationship between the first fixing member 620 and the first stop member 121 and a manner in which the first fixing member 620 is disengaged from the first stop member 121. The first fixing member 620 is disengaged from the first stop member 121 in the screwing manner, which is simple to operate and conducive to improving user experience.

This example further provides a power tool. The power tool includes a housing 100, an electric motor 200, and a switch assembly 300. The electric motor 200 is disposed at least partially in the housing 100, and the electric motor 200 includes a rotating shaft 210 rotatable about a first axis 211. The switch assembly 300 is for a user to operate to switch between a startup position and a shutdown position. The power tool further includes a fixing assembly 600. When the switch assembly 300 is at the startup position and the switch assembly 300 mates with the fixing assembly 600, the fixing assembly 600 is rotated to lock the switch assembly 300 at the startup position. With the above arrangement of the fixing assembly 600, when the electric motor 200 of the power tool rotates, even if a trigger 310 is touched by accident, the fixing assembly 600 is not triggered to rotate. Thus, the fixing assembly 600 does not change in position, and the trigger 310 is not unlocked so that the reliability with which the trigger 310 is locked is improved, and the rotation process of the electric motor 200 has relatively good reliability, thereby improving the work efficiency and quality.

This example further provides an operating method for a power tool. The power tool includes a housing 100, an electric motor 200, a switch assembly 300 for a user to operate to switch between a startup position and a shutdown position, and a fixing assembly 600 for the user to operate to lock the switch assembly 300 at the startup position. The operating method includes: when the switch assembly 300 is at the startup position and the switch assembly 300 mates with the fixing assembly 600, rotating the fixing assembly 600 to lock the switch assembly 300 at the startup position. With the above arrangement, when the electric motor 200 of the power tool rotates, even if a trigger 310 is touched by accident, the fixing assembly 600 is not triggered to rotate. Thus, the fixing assembly 600 does not change in position, and the trigger 310 is not unlocked so that the reliability with which the trigger 310 is locked is improved, and the rotation process of the electric motor 200 has relatively good reliability, thereby improving the work efficiency and quality.

A specific method for locking the trigger 310 is briefly described below. When the trigger 310 is at the shutdown position, the trigger 310 is pressed to the startup position. At this time, the electric motor 200 keeps rotating, and a button 610 is pressed so that a second fixing member 630 is inserted into a circular ring. The button 610 is rotated so that a first fixing member 620 mates with a first stop member 121. At this time, a second elastic member 640 is compressed, the button 610 is released, and a raised portion 621 is inserted into a recessed portion 1211 under the action of the second elastic member 640. Thus, the trigger 310 is locked at the startup position. When the trigger 310 is required to be unlocked, the button 610 is screwed so that the raised portion 621 is disengaged from the recessed portion 1211. The button 610 continues to be screwed so that the first fixing member 620 is disengaged from the first stop member 121 and moves to a side of a second stop member 122. The button 610 is released. Under the action of the second elastic member 640, the button 610 moves away from the housing 100 to drive the second fixing member 630 to be pulled out from the circular ring and to drive the first fixing member 620 to fit with the second stop member 122. At this time, the trigger 310 is unlocked, and under the action of a first elastic member 320, the trigger 310 automatically moves to the shutdown position.

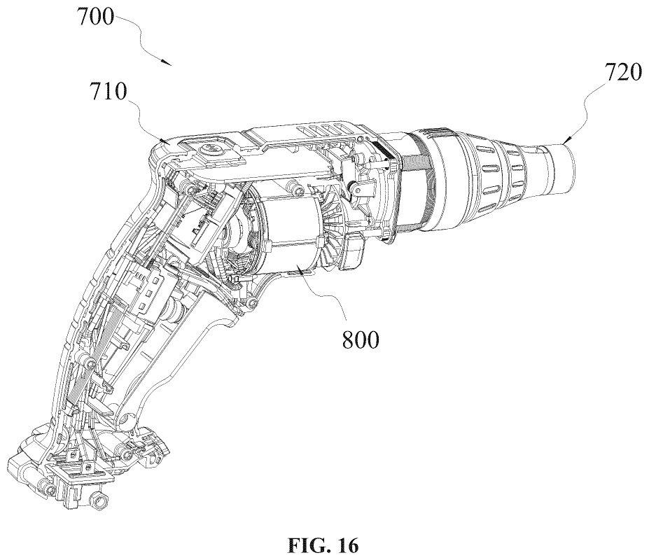

As shown in FIG. 16, this example provides a power tool 700, and the power tool 700 includes at least a housing 710, an electric motor 800 in the housing 710, a power supply, a switch, and a work head 720. The work head 720 is driven by the electric motor 800 to work.

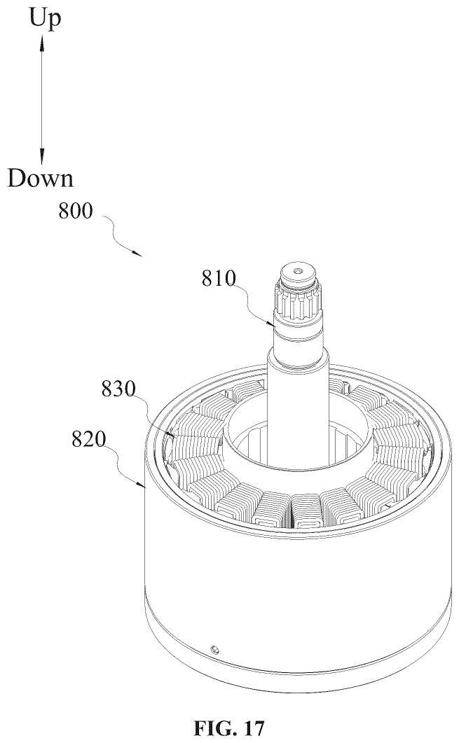

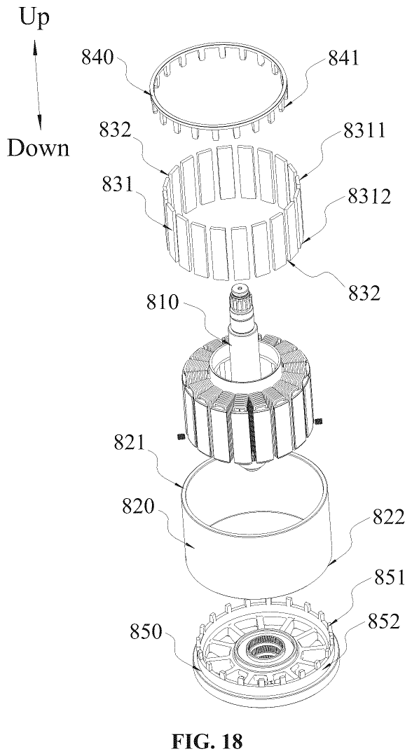

As shown in FIGS. 17 and 18, the electric motor 800 includes a motor shaft 810, a motor housing 820, a stator, and a rotor 830. The motor housing 820 forms a mounting space, the stator and the rotor 830 are both mounted in the mounting space formed by the motor housing 820, the motor shaft 810 is disposed in the mounting space, and an output end of the motor shaft 810 protrudes out of the mounting space. The stator is a fixed component fixed inside the motor housing 820. A main function of the stator is to generate a rotating magnetic field. The rotor 830 can rotate. A main function of the rotor 830 is to generate a current by being cut by magnetic lines of force in the rotating magnetic field. Specifically, the rotor 830 includes multiple magnetic steels 831. The multiple magnetic steels 831 extend along an axial direction of the motor housing 820, and the multiple magnetic steels 831 are evenly distributed and fixed on the inner surface of the motor housing 820. The multiple magnetic steels 831 may be fixed on the inner surface of the motor housing 820 through adhesion or in other manners, which are not limited in the present application.

The motor housing 820 includes a first end 821 and a second end 822 opposite to each other in the axial direction. The multiple magnetic steels 831 each include a third end 8311 and a fourth end 8312. The third end 8311 corresponds to the first end 821 and the fourth end 8312 corresponds to the second end 822. That is, when the first end 821 is the upper end of the motor housing 820 and the second end 822 is the lower end of the motor housing 820, the third end 8311 is the upper end of the magnetic steel 831 and the fourth end 8312 is the lower end of the magnetic steel 831. Similarly, when the first end 821 is the lower end of the motor housing 820 and the second end 822 is the upper end of the motor housing 820, the third end 8311 is the lower end of the magnetic steel 831 and the fourth end 8312 is the upper end of the magnetic steel 831. As shown in FIG. 18, the present application provides a specific description by using an example in which the first end 821 is the upper end of the motor housing 820 and the second end 822 is the lower end of the motor housing 820.

In some examples, as shown in FIG. 18, the electric motor 800 includes a first fixing structure 840 and a second fixing structure 850, where the first fixing structure 840 is disposed at the first end 821 of the motor housing 820, and the second fixing structure 850 is disposed at the second end 822 of the motor housing 820. The first fixing structure 840 and the second fixing structure 850 are configured to limit the multiple magnetic steels 831 from two ends of the motor housing 820 to prevent the magnetic steels 831 from moving along the axial direction of the motor housing 820. The first fixing structure 840 and the second fixing structure 850 are both components of the rotor 830.

As shown in FIG. 18, the second fixing structure 850 includes multiple second protrusion portions 851 arranged at intervals, and the multiple second protrusion portions 851 mate with fourth ends 8312 of the multiple magnetic steels 831. Specifically, the fourth ends 8312 of the multiple magnetic steels 831 form multiple insertion slots 832, and the multiple second protrusion portions 851 of the second fixing structure 850 are inserted into the multiple insertion slots 832 one to one to form tooth meshing similar to that between gears, thereby preventing the magnetic steels 831 from moving along a radial direction of the motor housing 820.

The first fixing structure 840 is disposed at the first end 821 of the motor housing 820 and mates with third ends 8311 of the multiple magnetic steels 831. Optionally, the first fixing structure 840 includes multiple first protrusion portions 841 arranged at intervals, the third ends 8311 of the multiple magnetic steels 831 also form multiple insertion slots 832, and the multiple first protrusion portions 841 of the first fixing structure 840 are inserted into the multiple insertion slots 832 one to one to form tooth meshing similar to that between gears, thereby preventing the magnetic steels 831 from moving along the radial direction of the motor housing 820. Optionally, the first fixing structure 840 is a fixing ring with a circular ring structure, a limiting groove matched with the fixing ring is provided on the inner surface of the motor housing 820, the fixing ring is engaged with the limiting groove, the fixing ring includes a portion protruding from the limiting groove, and the portion abuts against the third ends 8311 of the multiple magnetic steels 831, thereby preventing the magnetic steels 831 from moving along the radial direction of the motor housing 820. Additionally, the first fixing structure 840 may be any other structure that mates with the third ends 8311 of the multiple magnetic steels 831 and prevents the magnetic steels 831 from moving along the radial direction of the motor housing 820, which is not limited in the present application.

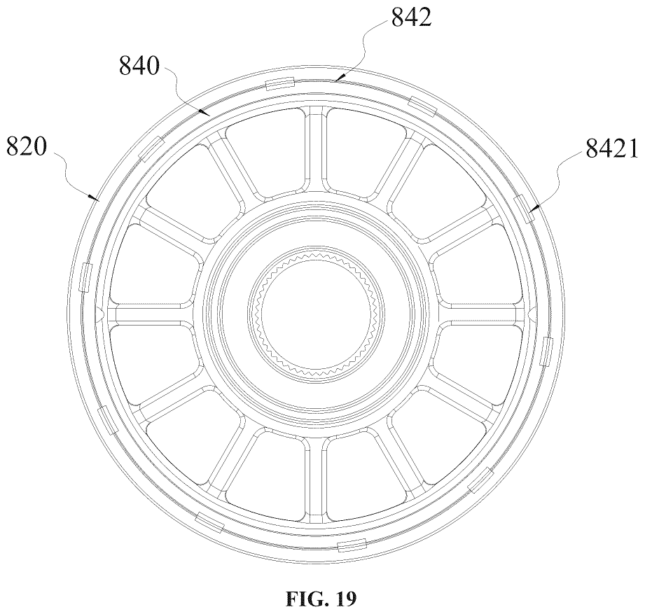

The first fixing structure 840 includes a contact portion 842 in contact with the motor housing 820, and the contact portion 842 of the first fixing structure 840 is welded to the motor housing 820. Optionally, the contact portion 842 may be directly melt-welded to the motor housing 820. Optionally, a filling component is provided between the contact portion 842 and the motor housing 820, and the contact portion 842 is indirectly melt-welded to the motor housing 820 based on the filling component. The filling component may be composed of any material that can melt-weld the contact portion 842 to the motor housing 820, which is not limited in the present application. As shown in FIG. 19, in the radial direction of the motor housing 820, the first fixing structure 840 includes the contact portion 842 in contact with the motor housing 820. Additionally, in the axial direction of the motor housing 820 or in any other direction of the motor housing 820, the first fixing structure 840 may include the contact portion 842 in contact with the motor housing 820. Optionally, when the contact portion 842 is directly or indirectly welded to the motor housing 820, at least two welding points 8421 are included, for example, FIG. 19 shows ten welding points 8421. Thus, the strength with which the first fixing structure 840 is welded to the motor housing 820 is ensured, the welding stability is enhanced, the first fixing structure 840 is prevented from falling off the motor housing 820, the effect of the first fixing structure 840 fixing the magnetic steels 831 to the motor housing 820 is further improved, the probability that the magnetic steels 831 are detached from the motor housing 820 is reduced, and the service life of the electric motor 800 is prolonged.

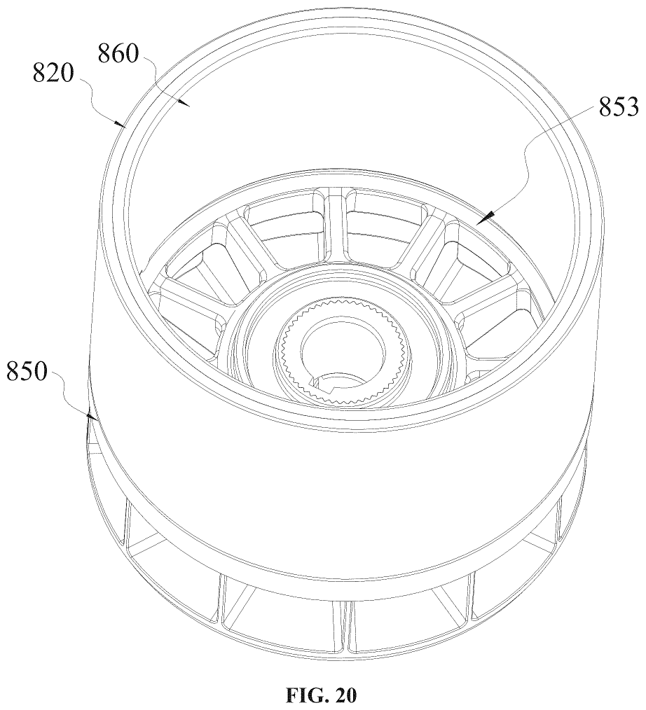

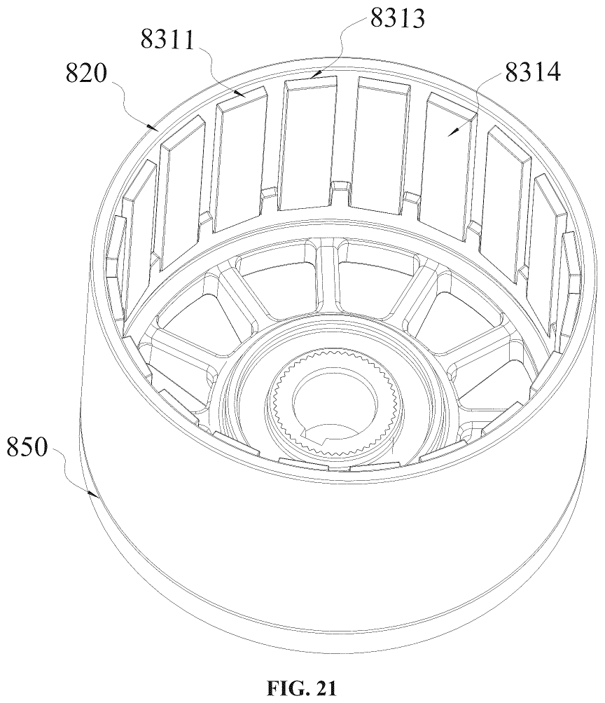

In some examples, as shown in FIG. 20, the electric motor 800 includes the second fixing structure 850 and a third fixing structure 860, which are configured to limit the multiple magnetic steels 831 to prevent the magnetic steels 831 from moving along the axial direction of the motor housing 820. The specific structure and fixing manner of the second fixing structure 850 are as described above and are not repeated here. As shown in FIG. 21, the multiple magnetic steels 831 each include a first surface 8313 and a second surface 8314, the first surface 8313 is a surface in contact with the inner surface of the motor housing 820, the second surface 8314 is opposite to the first surface 8313, and the second surface 8314 is a surface facing away from the inner surface of the motor housing 820. The third fixing structure 860 covers second surfaces 8314 of the multiple magnetic steels 831 and the inner surface of the motor housing 820 to fix the multiple magnetic steels 831 to the motor housing 820. The third fixing structure 860 also covers the third ends 8311 of the multiple magnetic steels 831 to further fix the multiple magnetic steels 831 to the motor housing 820. The third fixing structure 860 is a colloid fixing structure. Before the third fixing structure 860 covers the second surfaces 8314 of the multiple magnetic steels 831 and the inner surface of the motor housing 820, the third fixing structure 860 is in a fluid state. After the third fixing structure 860 covers the second surfaces 8314 of the multiple magnetic steels 831 and the inner surface of the motor housing 820, the third fixing structure 860 is in a solid state. After the third fixing structure 860 covers the second surfaces 8314 and the third ends 8311 of the multiple magnetic steels 831 and the inner surface of the motor housing 820, the multiple magnet steels 831 are encapsulated and fixed between the third fixing structure 860 and the inner surface of the motor housing 820, further improving the effect of fixing the multiple magnet steels 831 on the inner surface of the motor housing 820, reducing the probability that the magnet steels 831 are detached from the motor housing 820, and prolonging the service life of the electric motor 800 and the power tool 700.

Optionally, after the third fixing structure 860 covers the second surfaces 8314 and the third ends 8311 of the multiple magnetic steels 831 and the inner surface of the motor housing 820, the inner diameter of the electric motor 800 after coverage is 0.2-2.4 mm greater than the outer diameter of a stator core. Optionally, after the third fixing structure 860 covers the second surfaces 8314 and the third ends 8311 of the multiple magnetic steels 831 and the inner surface of the motor housing 820, the inner diameter of the electric motor 800 after coverage is 92.8 mm.

Optionally, as shown in FIG. 20, the third fixing structure 860 may completely cover the second surfaces 8314 of the multiple magnetic steels 831, the third ends 8311 of the multiple magnetic steels 831, and the inner surface of the motor housing 820. Optionally, the third fixing structure 860 may cover the third ends 8311 of the multiple magnetic steels 831, part of the second surfaces 8314 of the multiple magnetic steels 831, and the corresponding inner surface of the motor housing 820. The corresponding inner surface of the motor housing 820 is an inner surface on the same circumference as the covered part of the multiple magnetic steels 831 so that the multiple magnetic steels 831 are further fixed on the inner surface of the motor housing 820. The specific part of the multiple magnetic steels 831 and the corresponding inner surface, which are covered by the third fixing structure 860, are not limited in the present application.

In some examples, the second fixing structure 850 includes an annular frame 852, and the multiple second protrusion portions 851 arranged at intervals are arranged on the annular frame 852. As shown in FIG. 20, the second fixing structure 850 further includes a choke structure 853 disposed on the inner wall of the annular frame 852 and configured to limit the third fixing structure 860. When the third fixing structure 860 is in the fluid state and is to cover the second surfaces 8314 of the multiple magnetic steels 831 and the inner surface of the motor housing 820, the choke structure 853 is configured to block the flowing third fixing structure 860 from leaking out from connecting holes on the second fixing structure 850. Optionally, the choke structure 853 may be integrally formed with the annular frame 852. Optionally, the choke structure 853 is a separate structure fixed to the annular frame 852. A fixing manner of the choke structure 853 is not limited in the present application. The choke structure 853 may be made of a metal such as aluminum. Additionally, the choke structure 853 may be made of other materials, which are not limited in the present application.

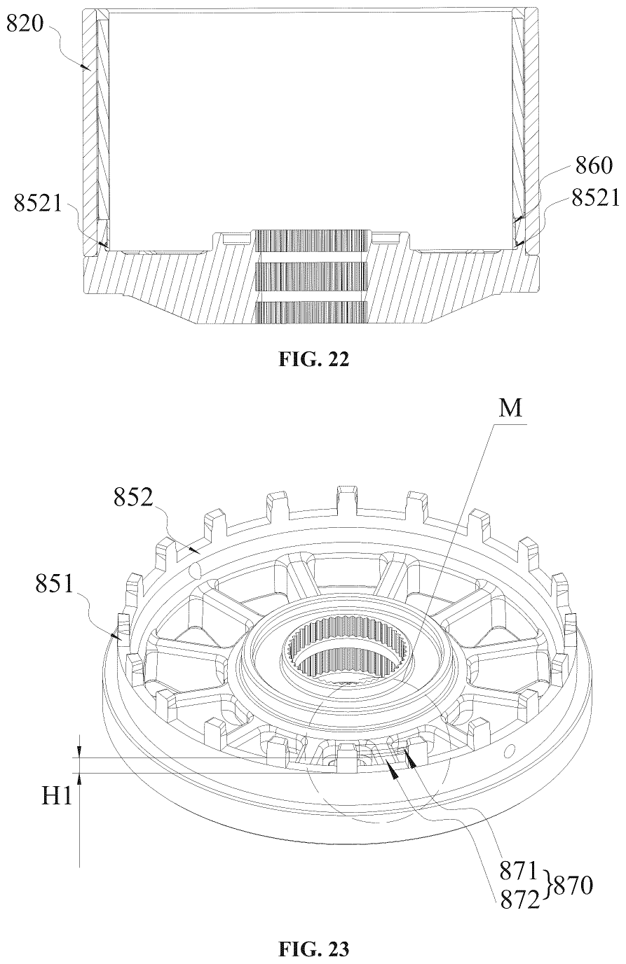

In some examples, as shown in FIG. 22, the annular frame 852 of the second fixing structure 850 is provided with a limiting groove 8521, and the limiting groove 8521 is configured to accommodate part of the third fixing structure 860 when the third fixing structure 860 is in the fluid state and is to cover the second surfaces 8314 of the multiple magnetic steels 831 and the inner surface of the motor housing 820. Thus, when the third fixing structure 860 is in the solid state, part of the third fixing structure 860 is engaged with the limiting groove 8521, thereby reducing the probability that the third fixing structure 860 falls off the motor housing 820 and further reducing the probability that the magnetic steels 831 are detached from the motor housing 820.

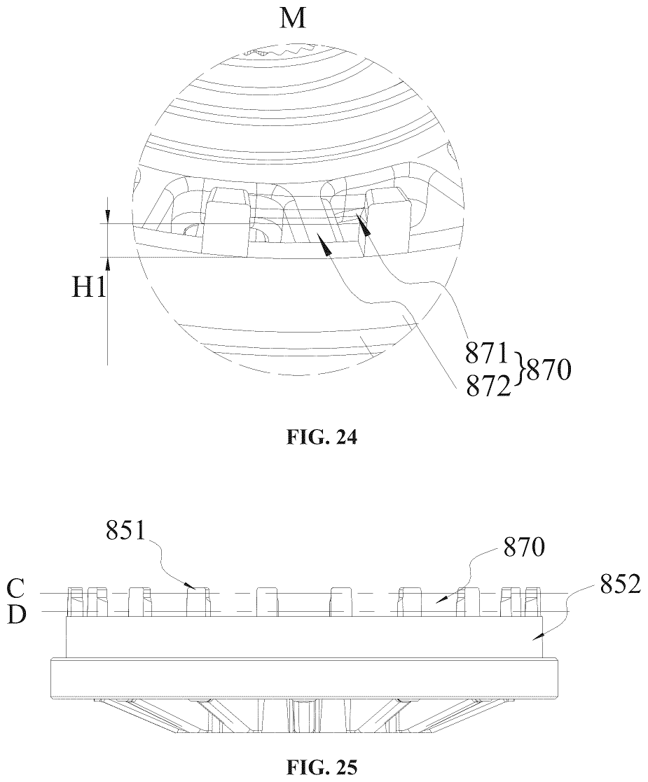

In some examples, as shown in FIGS. 23 and 24, every two adjacent second protrusion portions 851 of the multiple second protrusion portions 851 included in the second fixing structure 850 form an accommodation space 870, the accommodation space 870 includes a first accommodation space 871 and a second accommodation space 872, and the second accommodation space 872 is different from the first accommodation space 871. The second accommodation space 872 is configured to mate with the fourth end 8312 of each of the multiple magnetic steels 831 to prevent the magnetic steels 831 from moving along the radial direction of the motor housing 820.

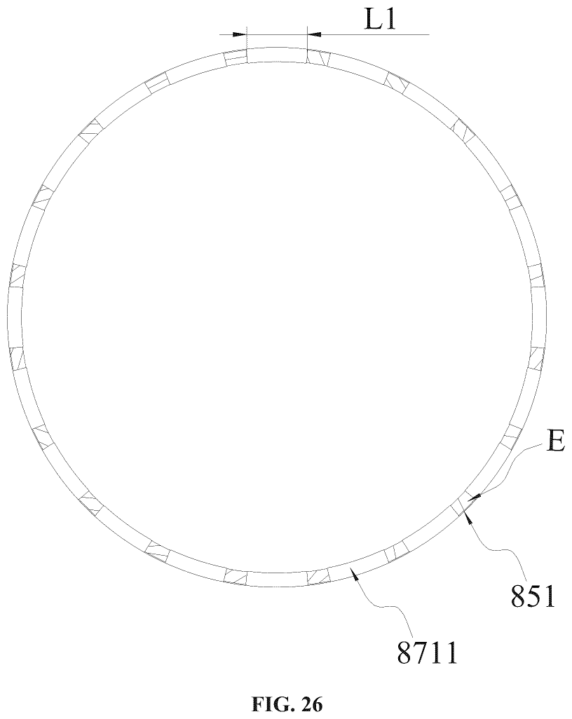

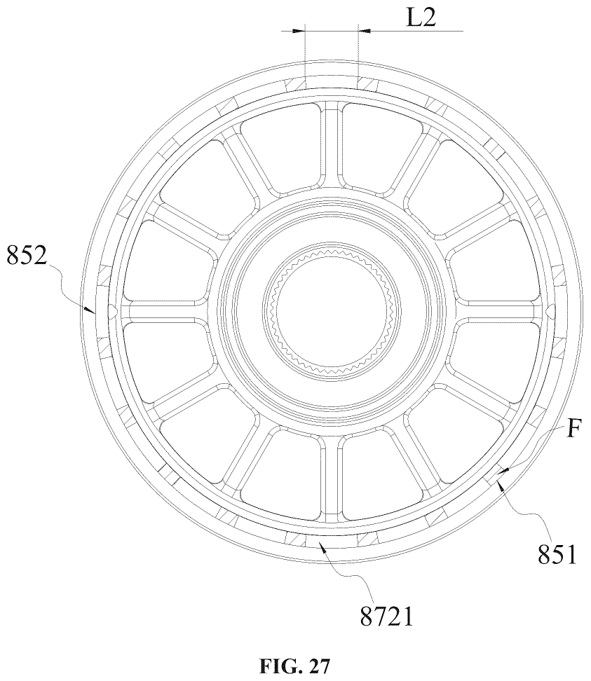

In some examples, in a direction perpendicular to the axial direction of the motor housing 820, the first accommodation space 871 includes a first accommodation surface 8711, the second accommodation space 872 includes a second accommodation surface 8721, and the first accommodation surface 8711 has a greater area than the second accommodation surface 8721. As shown in FIG. 25, in the direction perpendicular to the axial direction of the motor housing 820, a first cross section C and a second cross section D are formed along a circle of the second protrusion portions 851, the first cross section C is a cross section passing through the first accommodation space 871, and the second cross section D is a cross section passing through the second accommodation space 872. As shown in FIG. 26, FIG. 26 shows a section E of the second protrusion portion 851 on the first cross section C, and the first accommodation surface 8711 is formed between every two of multiple sections E. As shown in FIG. 27, FIG. 27 shows a section F of the second protrusion portion 851 on the second cross section D, and the second accommodation surface 8721 is formed between every two of multiple sections F.

Optionally, the first accommodation surface 8711 is in the shape of a rectangle, the second accommodation surface 8721 is in the shape of a trapezoid, and the length L2 of the lower base of the trapezoid of the second accommodation surface 8721 is less than or equal to the length L1 of the rectangle of the first accommodation surface 8711. The second fixing structure 850 further includes the annular frame 852, and the multiple second protrusion portions 851 are arranged on the annular frame 852 and form the accommodation space 870. The lower base of the trapezoid of the second accommodation surface 8721 is located on the outer ring of the annular frame 852, the upper base of the trapezoid of the second accommodation surface 8721 is located on the inner ring of the annular frame 852, the diameter of the inner ring of the annular frame 852 is less than the diameter of the outer ring of the annular frame 852, and the length of the lower base of the trapezoid of the second accommodation surface 8721 is greater than the length of the upper base of the trapezoid of the second accommodation surface 8721. The inner ring of the annular frame 852 is an inner circle of the annular frame 852 closer to the motor shaft 810, and the outer ring of the annular frame 852 is an outer circle of the annular frame 852 farther away from the motor shaft 810.

The fourth end 8312 of each of the multiple magnetic steels 831 includes a plane perpendicular to the axial direction of the motor housing 820, and the plane of the fourth end 8312 is in the shape of a trapezoid. Specifically, the plane of the fourth end 8312 is in the same shape as the second accommodation surface 8721, and the plane of the fourth end 8312 has the same area as the second accommodation surface 8721, that is, the trapezoid of the plane of the fourth end 8312 and the trapezoid of the second accommodation surface 8721 are identical in shape and size. Therefore, the length of the lower base of the trapezoid of the plane of the fourth end 8312 is also less than or equal to the length L1 of the rectangle of the first accommodation surface 8711.

When the multiple magnetic steels 831 are mounted and fixed in a circle on the inner surface of the motor housing 820 along a direction from the center of the electric motor 800 to the outer circumference of the electric motor 800 (that is, from the motor shaft 810 to the motor housing 820), the fourth ends 8312 of the multiple magnetic steels 831 firstly mate with first accommodation spaces 871 in the direction perpendicular to the axial direction of the motor housing 820. The fourth ends 8312 enter the first accommodation spaces 871 along the direction from the center of the electric motor 800 to the outer circumference of the electric motor 800, and the lower base of the rectangle of the plane of the fourth end 8312 enters the first accommodation space 871 along the direction from the center of the electric motor 800 to the outer circumference of the electric motor 800. Since the length L1 of the rectangle of the first accommodation space 871 is greater than or equal to the length of the lower base of the rectangle of the plane of the fourth end 8312, the fourth ends 8312 of the multiple magnetic steels 831 can enter the first accommodation spaces 871. Then, the fourth ends 8312 of the multiple magnetic steels 831 mate with second accommodation spaces 872 along the axial direction of the motor housing 820. Specifically, the fourth ends 8312 of the multiple magnetic steels 831 enter the second accommodation spaces 872 from top to bottom along the axial direction of the motor housing 820. Since the plane of the fourth end 8312 and the second accommodation surface 8721 are substantially the same in shape and size, the fourth ends 8312 can be completely engaged with the second accommodation spaces 872. Optionally, when the first fixing structure 840 mates with the third ends 8311 of the multiple magnetic steels 831, the first fixing structure 840 is assembled from top to bottom along the axial direction of the motor housing 820 so that the fourth ends 8312 of the multiple magnetic steels 831 enter the second accommodation spaces 872. Optionally, the second accommodation space 872 includes a height H1 along the axial direction of the motor housing 820, where the height H1 is greater than or equal to 1 mm. The greater the height H1, the stronger the strength with which the fourth ends 8312 of the multiple magnetic steels 831 are engaged with the second accommodation spaces 872. Optionally, the height H1 may be 3 mm.

Additionally, in some examples, the second accommodation surface 8721 may be in any shape other than the trapezoid as long as the length of the lower base (located on the outer ring of the annular frame 852) is greater than that of the upper base (located on the inner ring of the annular frame 852). The plane of the fourth end 8312 of the magnetic steel 831 is the same as the second accommodation surface 8721 in size and shape.

The third ends 8311 of the multiple magnetic steels 831 are fixed by the first fixing structure 840. The accommodation space 870 of the second fixing structure 850 is divided into two accommodation spaces. The fourth ends 8312 of the multiple magnetic steels 831 enter the first accommodation spaces 871 along the direction from the center of the electric motor 800 to the outer circumference of the electric motor 800, and the fourth ends 8312 of the multiple magnetic steels 831 are engaged with the second accommodation spaces 872. The length of the lower base of the plane of the fourth end 8312 is greater than the length of the upper base of the plane of the fourth end 8312, that is, the length of the lower base of the plane of the fourth end 8312 is greater than the length of the upper base of the second accommodation surface 8721. Thus, even when the electric motor 800 runs at a high speed, the lower base of the plane of the fourth end 8312 cannot be detached from the upper base of the second accommodation surface 8721, the fourth ends 8312 of the magnetic steels 831 cannot be detached from the second accommodation spaces 872, and the magnetic steels 831 do not fall off the electric motor 800 in the radial direction.

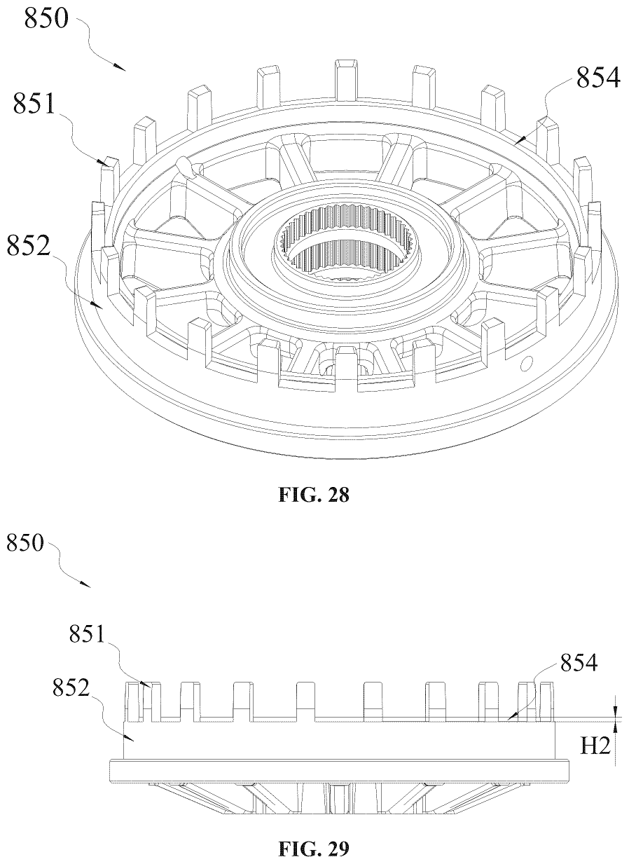

In some examples, as shown in FIGS. 28 and 29, the second fixing structure 850 includes a first limiting component 854 disposed in a circle on the inner wall of the annular frame 852. The first limiting component 854 may be integrally formed with the annular frame 852. Along the axial direction of the motor housing 820, the first limiting component 854 includes a protruding portion protruding from the annular frame 852. The height of the protruding portion is H2 so that the magnetic steels 831 can be prevented from moving along the radial direction of the motor housing 820. Optionally, the height H2 is greater than or equal to 1 mm. The greater the height H2, the better the magnetic steels 831 can be prevented from moving along the radial direction of the motor housing 820. Optionally, the height H2 may be 1 mm. Optionally, the shape of the magnetic steel 831 in a plane perpendicular to the axial direction of the motor housing 820 may be a rectangle, a trapezoid, a hexagon, or any other shape that can match the accommodation space 870 of the second fixing structure 850, which is not limited in the present application. Optionally, along the axial direction of the motor housing 820, the distance between a stator end plate and the first limiting component 854 is greater than or equal to 0.5 mm. For example, the distance between the stator end plate and the first limiting component 854 may be 1.25 mm.

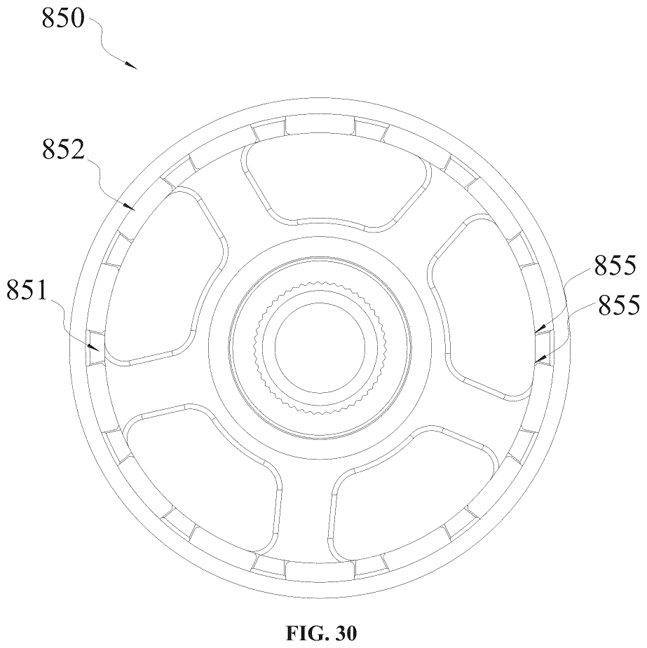

In some examples, as shown in FIG. 30, the second fixing structure 850 includes second limiting components 855 disposed on the multiple second protrusion portions 851 on the annular frame 852. Specifically, a second limiting component 855 is disposed on an inner wall of each second protrusion portion 851 and extends from the left or right side of the second protrusion portion 851 in the direction perpendicular to the axial direction of the motor housing 820 to prevent the magnetic steel 831 from moving along the radial direction of the motor housing 820. When the magnetic steels 831 are fixedly mounted on the inner surface of the motor housing 820, the second limiting components 855 can abut against the magnetic steels 831 to prevent the magnetic steels 831 from moving along the radial direction of the motor housing 820. Optionally, the second limiting component 855 may be integrally formed with the second protrusion portion 851. Optionally, the shape of the magnetic steel 831 in the plane perpendicular to the axial direction of the motor housing 820 may be a rectangle, a trapezoid, a hexagon, or any other shape that can match the accommodation space 870 of the second fixing structure 850, which is not limited in the present application.

Additionally, in some examples, the first fixing structure 840 may also include the first limiting component 854 or the second limiting components 855.

The first fixing structure 840 and the second fixing structure 850 described above are non-elastic, that is, the first fixing structure 840 and the second fixing structure 850 do not undergo elastic deformation during the assembly with the motor housing 820. In some examples, at least part of the first fixing structure 840 and at least part of the second fixing structure 850 may be elastic so that the first fixing structure 840 and the second fixing structure 850 can undergo elastic deformation during the assembly with the motor housing 820 to reduce difficulties in assembling the first fixing structure 840 with the motor housing 820 and assembling the second fixing structure 850 with the motor housing 820.

In some examples, the electric motor 800 further includes a fan connected to the motor shaft 810 so that the fan can rotate synchronously with the motor shaft 810 to perform heat dissipation on the electric motor 800.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
a housing;
an electric motor disposed at least partially in the housing and comprising a rotating shaft rotatable about a first axis;
a switch assembly moveable between a startup position and a shutdown position, wherein the switch sends a startup signal to the electric motor assembly in the startup position and sends a shutdown signal to the electric motor in the shutdown position; and
a directional assembly for a user to operate to control a rotation direction of the electric motor, wherein the directional assembly is configured to mate with the switch assembly to lock the switch assembly at the startup position and to disengage from the switch assembly to unlock the switch assembly whereupon the switch assembly switches to the shutdown position.

2. The power tool according to claim 1, wherein the directional assembly comprises a directional member and a first stop portion disposed on the directional member, the switch assembly comprises a trigger and a second stop portion disposed on the trigger, and the first stop portion and the second stop portion mate with each other so that the directional member locks the trigger at the startup position.

3. The power tool according to claim 2, wherein the directional member is disposed on the housing and rotatable relative to the housing.

4. The power tool according to claim 2, wherein the first stop portion comprises a protrusion disposed on the directional member and extending toward the trigger, the second stop portion comprises a groove disposed on the trigger and opened toward the directional member, and when the trigger is at the startup position and the protrusion is inserted into the groove, the directional member locks the trigger at the startup position.

5. The power tool according to claim 4, wherein, when the trigger is at the startup position, a surface of the groove abutting against the protrusion is an arc-shaped surface.

6. The power tool according to claim 4, wherein the directional member is disposed above the trigger and switchable between a forward rotation position, a reverse rotation position, and a locking position, when the directional member is at the locking position, the protrusion is inserted into the groove, and, when the directional member is at the forward rotation position and the reverse rotation position, the protrusion is removed from the groove.

7. The power tool according to claim 6, wherein, when the directional member is at the forward rotation position and the reverse rotation position, the directional member unlocks the trigger.

8. The power tool according to claim 7, further comprising a first elastic member disposed between the trigger and the housing, wherein, when the directional member is at the forward rotation position and the reverse rotation position, the first elastic member causes the trigger to return to the shutdown position.

9. The power tool according to claim 8, wherein a dust shield is sleeved on an outer circumference of the first elastic member.

10. The power tool according to claim 6, wherein the forward rotation position and the reverse rotation position are located on left and right sides of the locking position respectively, the trigger is provided with a slide slot on each of left and right sides of the groove, the left and right sides of the groove each communicate with a corresponding slide slot, and when the directional member is at the forward rotation position and the reverse rotation position, the protrusion is slidable in the corresponding slide slot.

11. The power tool according to claim 10, wherein the slide slot comprises a sidewall for stopping the protrusion, and when the trigger is at the shutdown position, the sidewall prevents the directional member from moving from the forward rotation position or the reverse rotation position to the locking position.

12. The power tool according to claim 6, wherein, when the directional member moves to the forward rotation position, a forward rotation circuit of the power tool is connected so that the electric motor keeps rotating forward when the trigger is at the startup position.

13. The power tool according to claim 12, further comprising a forward rotation trigger element, wherein the forward rotation trigger element is triggered when the directional member moves to the forward rotation position, and after triggered, the forward rotation trigger element sends a forward rotation signal to a controller of the power tool, and the controller controls the forward rotation circuit to be connected and keeps the forward rotation circuit connected.

14. The power tool according to claim 6, wherein, when the directional member moves to the reverse rotation position, a reverse rotation circuit of the power tool is connected so that the electric motor keeps rotating reversely when the trigger is at the startup position.

15. The power tool according to claim 14, further comprising a reverse rotation trigger, wherein the reverse rotation trigger is triggered when the directional member moves to the reverse rotation position, and after triggered, the reverse rotation trigger sends a reverse rotation signal to a controller of the power tool, and the controller controls the reverse rotation circuit to be connected and keeps the reverse rotation circuit connected.

16. An operating method for a power tool comprising an electric motor, a switch assembly moveable between a startup position in which the switch assembly sends a startup signal to the electric motor and a shutdown position in which the switch assembly sends a shutdown signal to the electric motor, and a directional assembly for a user to operate to control a rotation direction of the electric motor, the operating method comprising:
operating the directional assembly to unlock the switch assembly when the directional assembly is mated with the switch assembly to lock the switch assembly at the startup position whereupon the switch assembly switches to the shutdown position.

17. The operating method for a power tool according to claim 16, wherein the directional assembly comprises a directional member and a first stop portion disposed on the directional member, the switch assembly comprises a trigger and a second stop portion disposed on the trigger, and when the switch assembly is locked at the startup position, the first stop portion and the second stop portion are operated to mate with each other.

18. The operating method for a power tool according to claim 17, wherein the first stop portion comprises a protrusion disposed on the directional member and extending toward the trigger, and the second stop portion comprises a groove disposed on the trigger and opened toward the directional member.

19. The operating method for a power tool according to claim 18, wherein when the switch assembly is locked at the startup position, the protrusion is operated to be inserted into the groove.

20. The operating method for a power tool according to claim 18, wherein the trigger is provided with a slide slot on each of left and right sides of the groove, the left and right sides of the groove each communicate with a corresponding slide slot, and when the directional assembly unlocks the switch assembly, the protrusion is operated to move into the slide slot.
